(19) United States
(12) Patent Application Publication
(10) Pub. No.: US 2016/0195199 A1
(43) Pub. Date: Jul. 7, 2016

(54) VALVE COMPRISING A ROTARY, ADJUSTBALE FLOW-BLOCKING SYSTEM

(71) Applicant: Manuel LARA-CASTRO, San Pedro Garza Garcia (MX)

(72) Inventor: Manuel LARA-CASTRO, San Pedro Garza Garcia (MX)

(21) Appl. No.: 14/787,864

(22) PCT Filed: Apr. 29, 2013
(86) PCT No.: PCT/MX2013/000055

§ 371 Date: Mar. 24, 2016

(51) Int. Cl. F16K 37/00; F16K 3/08

(52) U.S. Cl. CPC F16K 37/0016; F16K 3/085

(57) ABSTRACT

A valve having a rotary flow blocking system having a mechanism to regulate the opening of the rotary flow blocking system.

### BACKGROUND OF THE INVENTION

A. Field of the Invention

The present invention is related to hydraulic valves for controlling fluid flow (liquids, gases, etc.) and more particularly to a valve having a rotary flow blocking system including a mechanism to regulate the opening of the rotary flow blocking system.

B. Description of the Related Art

The valves are mechanical devices for controlling flow or pressure in a pipeline or between components of a machine. The valves may be automatic, such as valves operated by the pressure exerted by a spring, or non-automatic valves such as a stopcock valve operated by rotating an actuator.

The typical valve consists of a main body and an actuator. The body has a housing including a variable orifice through which the liquid passes. The actuator provides the energy to move a seal which can be a plug, to vary the orifice flow area. The movement of the operator is transmitted through a screw or a bellows, to move the seal.

The most common valve designs are the butterfly valve, diaphragm valve and sliding stem valve.

The butterfly valve comprises a toroidal shaped main body having disk shaped seal located within the cavity of the toroidal body and mounted on a shaft diametrically passing through said disc. The valve can be opened or closed to the flow by turning the disc-shaped seal on its own axis. This type of valve has the advantage of being economic in large quantities and can be provided with a rubber gasket to increase the degree of sealing of the valve, however, the butterfly valve is not suitable for connection to high pressure fluid lines, because the disk-shaped seal tends to rotate about its own axis when a high pressure strikes on its surface, causing fluid leakage.

The diaphragm valve comprises a main body including an orifice having a diaphragm which is pushed by an actuator to interrupt the flow through the orifice. The diaphragm may be made of various elastic materials such as plastic, which makes this type of valve suitable for use with slurries and/or corrosive chemicals but due to the characteristics of said elastic material, the diaphragm valve is not suitable for use at high temperatures and fluid pressures, due to the tendency of plastic materials to soften and/or torn and in extreme cases to melt.

The sliding stem valve is the most commonly used valve in domestic water networks. The main body of this kind of valve may have various configurations, each of which has a flow passage inside and a seal mounted on an actuator, which consists of a threaded bar that is able to partially enter or exit the valve body so that it pushes the seal into the flow passage to interrupt its passage through the passage. Usually the seal comprises a metallic disc including a rubber seal, both having a shape adapted to the shape of the passage flow in order to achieve a proper seal between the seal and the walls of the passage. This kind of valve has the advantage of being economical, simple and broadly available, but has several disadvantages. One of its main disadvantages is the low durability of its components, for example the rubber gasket, which after some use, begins to wear of the edges or even to break, causing leakage of liquid, or the threaded bar tends to wear, causing the bar to lose its thrusting force, which causes a bad seal between the seal and the flow passage. Furthermore, since the static pressure that the valve can withstand without leakage problems depends on the force that the valve operator applies to the actuator, when a excessive force is applied to the actuator the actuator-seal body tends to be destroyed, which forces the frequent replacement of the seal.

Mexican patent No. 264271 claims a valve having a rotary flow blocking system which overcomes many of the disadvantages of the above mentioned valve types, wherein said valve having a rotary flow blocking system comprising: a) a solid two-pieces main valve body constituted by a first valve section and a second valve section, each valve section having: a central perforation having means to retain the valve sections against rotation from one another; an internal end and an external end; and one or more fluid passages surrounding the central perforation; the external end including means to be coupled to a pipeline; a rotary dosing body to be coupled between the first valve section and the second valve sections, including: a central perforation; and one or more fluid passages surrounding the central perforation to regulate or interrupt a flow of fluid in association with the fluid passages of the first valve section and second valve section; a shaft, passing through the central perforation of the first valve section, the rotary dosing body and the second valve section, having: two ends; means to firmly coupling the first valve section, the rotary dosing body and the second valve section located at each end; and means to retain the two valve sections against rotation from one another cooperating with the means of the central perforation.

One problem of the aforementioned valve is that the opening of the rotary dosing body cannot be accurately regulated as there is no way to precisely know the opening percentage of the dosing body or the amount of water that can pass through the valve, which is very important to know especially for water distribution companies, which sometimes need to control the flow of water coming into a home.

In view of the above, applicant developed a valve having a rotary flow blocking system having a mechanism to regulate the opening of the rotary flow blocking system, wherein the rotary flow blocking system is similar to that described in Mexican patent No. 264,271.

The valve having a rotary flow blocking system having a mechanism to regulate the opening of the rotary flow blocking system of the present invention flow comprises:

### SUMMARY OF THE INVENTION

It is therefore a main object of the present invention to provide a valve having a rotary flow blocking system having a mechanism to regulate the opening of the rotary flow blocking system.

It is another object of the present invention to provide a valve having a rotary flow blocking system having a mechanism to regulate the opening of the rotary flow blocking system which allows to accurately regulate the opening of the rotary dosing body.

These and other objects and advantages of the valve having a rotary flow blocking system having a mechanism to regulate the opening of the rotary flow blocking system of the present invention will become apparent to those persons having an ordinary skill in the art, from the following detailed description of the embodiments of the invention which will be made with reference to the accompanying drawings.

### BRIEF DESCRIPTION OF THE DRAWINGS

FIG. 1 is a right side perspective exploded view of the valve of the present invention.

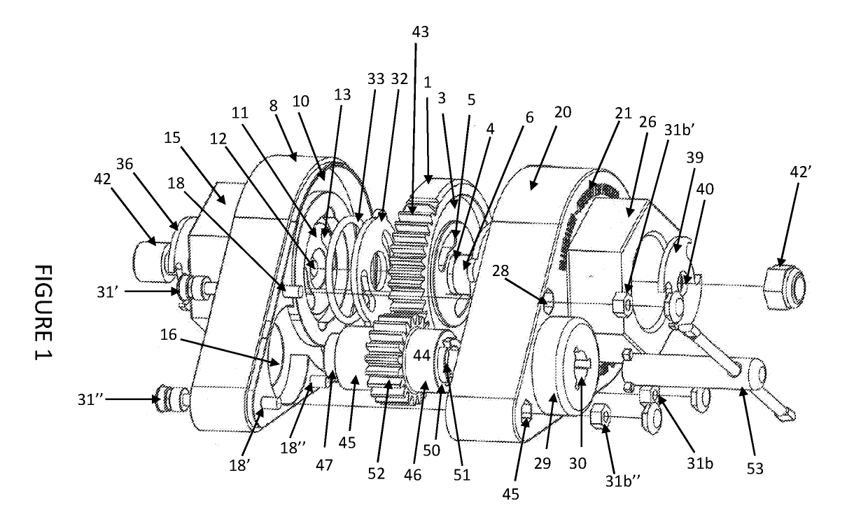

FIG. 2 is a bottom perspective exploded view of the valve of the present invention.

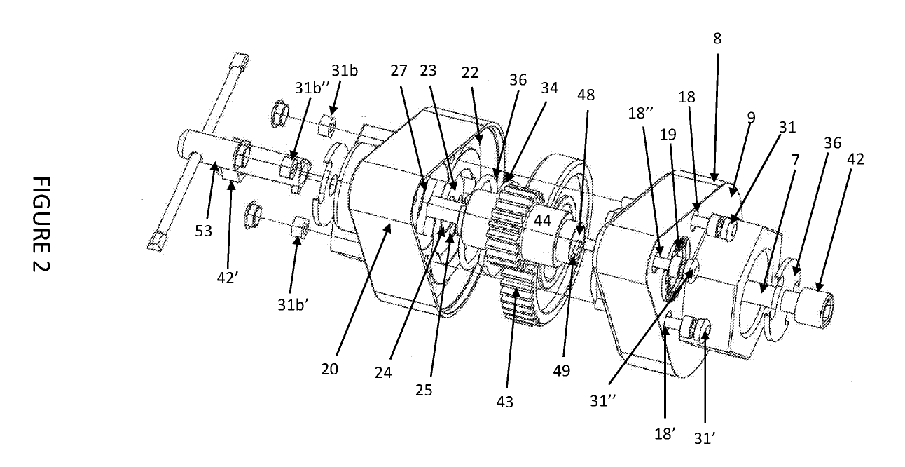

FIG. 3 is a top exploded view of the valve of the present invention.

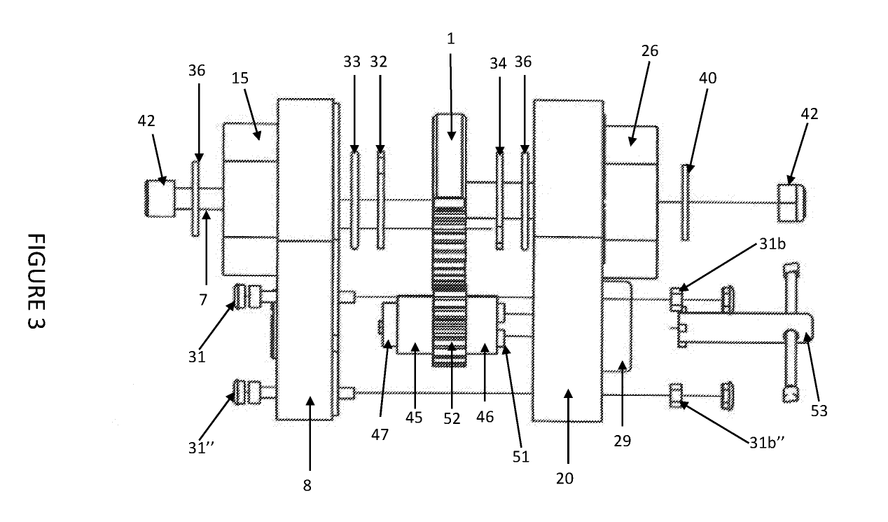

FIG. 4 is a top view of the valve of the present invention.

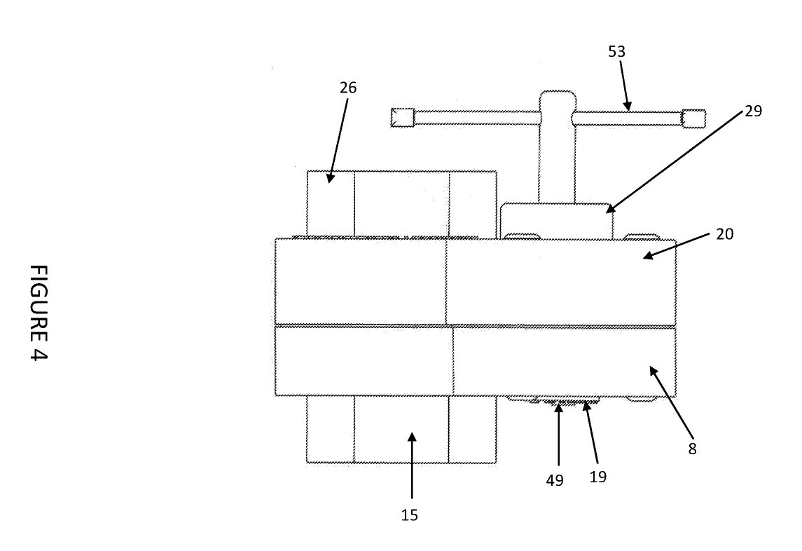

FIG. 5 is a left side view of the valve of the present invention.

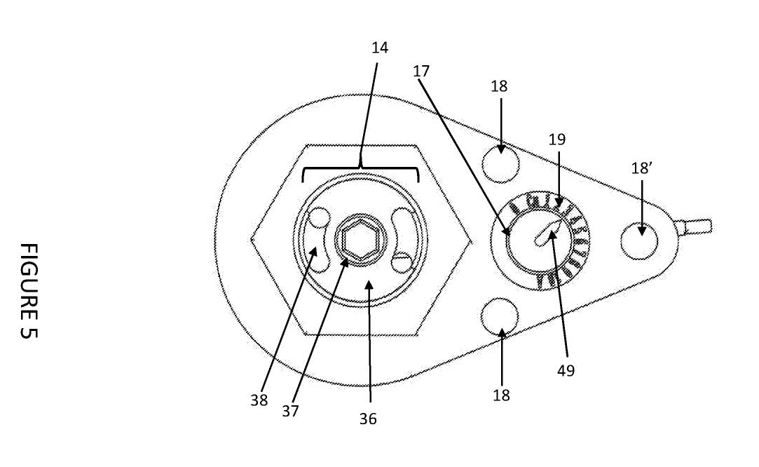

FIG. 6 is a left bottom perspective of the valve of the present invention.

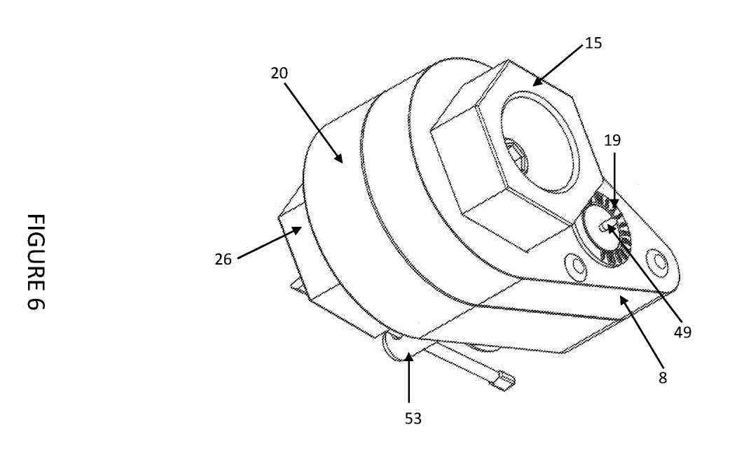

### DETAILED DESCRIPTION OF THE INVENTION

The invention will be described in accordance with a preferred embodiment thereof and making reference to the accompanying drawings, wherein the same signs and numbers refer to the same elements.

The valve having a rotary flow blocking system having a mechanism to regulate the opening of the rotary flow blocking system of the present invention will now be described referring to a valve having a rotary flow blocking system which is similar to the one described in Mexican patent No. 264271 which comprises:

a central rotary dosing body (1) having a first face (2) and a second face (3), a central bore (4), and one or more passages having a groove shape (5) surrounding the central perforation (4); and

a shaft (6) having a first end (7) and second end, each of which has a thread pattern and which sealingly passes through the central bore (4) of dispenser body (1);

wherein the valve having a rotary flow blocking system having a mechanism to regulate the opening of the rotary flow blocking system comprises:

a first valve section (8), having a generally triangular shape, an outer side (9) having an outer surface and an inner side (10) comprising:
a central circular a housing (11) located on the inner side (10) having a receiving surface and a central bore (12) passing through the first valve section (8) to its outer surface;
one or more water passages (13) having a groove shape surrounding the central bore (12) and passing through the first valve section (8) to its outer surface;
an external liquid inlet (14) formed by the one or more water passages (13) having a groove shape, passing through the first valve section (8) to its outer surface and which surround the central bore (12) of the central circular housing (11) passing through the first valve section (8) to its outer surface;
means for attaching the outer liquid inlet of the first valve section to a pipe or other components, said means comprising a tubular thread connection (15) surrounding external liquid inlet (14) which protrudes from the outer surface the first valve section (8);
an eccentric circular housing (16), located on the inner side, next to the central circular housing (11) having a central bore (17);
three equidistant holes (18, 18′, 18″) surrounding the eccentric circular housing (16);
a circular measurement mark (19) located at the outer surface of the first valve section (8), concentrically coinciding with the central bore (17) of the eccentric circular housing (16) which passes to the outer surface of the first valve section (8);

a second valve section (20), having a generally triangular shape, an outer side (21) having an outer surface and an inner side (22), comprising:
a central circular housing (23) located on the inner side (22) having a receiving surface and a central bore (24) passing through the second valve section (20) to its outer surface;
one or more water passages having a groove shape (25), surrounding the central bore (24) and passing through the second valve section (20) to its outer surface;
an external liquid inlet (not shown) formed by one or more water passages (25) having a groove shape, passing through the second valve section (20) to its outer surface and which surround the central bore (24) of the central circular housing (23) passing through the second valve section (20) to its outer surface;
means for attaching the outer liquid inlet of the second valve section to a pipe or other components, said means comprising a threaded tubular connection (26) surrounding the external liquid inlet and protruding from the outer surface of the second section valve (20);
an eccentric circular housing (27), located next to the central circular housing (23), having a central bore (not shown);
three equidistant holes (28, 28′) (third hole not shown) surrounding the eccentric circular housing (27);
a cylindrical shaped tunnel (29) located at the outer end of the second valve section (20), having a cross section with a specific shape (30), coinciding with the central bore of eccentric circular housing (27);

a first screw (31), a second screw (31′) and a third screw (31″), each having a first and a second end, each respectively passing through three equally spaced holes (18, 18′, 18″) surrounding the eccentric circular housing (16) of the first valve section (8) and the second end of each screw, protrudes from the three equally spaced holes (28) (28′) surrounding the eccentric circular housing (27) of the second valve section (20), wherein the second end of each screw receives a nut (31b, 31b, 31b″), thereby joining the two valve sections (8), (20);

a first fixed gasket having a circular shape (32) tightly housed inside the central circular housing (11) of the first valve section (8) and tightly contacting the first face (2) of the central rotary dosing body (1), said first fixed gasket (32) having a central bore and one or more passages having a groove shape surrounding the central bore, which completely coincide with the one or more passages having a groove shape (5) of the central rotary dosing body (1) when the valve is in an “open” portion and with passages in the form of grooves (13) of the central circular a housing (11) of the first valve section (8);

a first fixed gasket having a ring shape (33) tightly housed in the central circular a housing (11) of the first valve section (8) between the receiving surface of the central circular a housing (11) and the first fixed gasket having a circular shape (32);

a second fixed gasket having a circular shape (34), tightly housed inside the central circular housing (23) of the second valve section (20) and tightly contacting the second side (3) of the central rotary dosing body (1), said second fixed gasket having a central bore and one or more passages having a groove shape surrounding the central bore, which completely match one or more passages having a groove shape (5) of the central rotary dosing body (1) when the valve is in an “open” portion, and with the one or more water passages having a groove shape (25) of the central circular housing (23) of the second valve section (20);

a second fixed gasket having a ring shape (35) tightly housed inside the central circular housing (23) of the second valve section (20) between the receiving surface of the central circular housing (23) and the second fixed gasket having a circular shape (34);

a first external gasket (36) attached to the external liquid inlet (14) of the first valve section (8), having a central bore (37) which coincides with the central bore (12) of the central circular housing (11) passing through the first valve section (8) to its outer surface and with one or more grooves (38) that coincide with the one or more water passages (13) passing through the first valve section (8) to its outer surface;

a second outer gasket (39) attached to the outer liquid inlet of the second valve section (20), having a central bore (40) which coincides with the central bore (24) of the central circular housing (23) passing through the second valve section (20) to its outer surface and with one or more grooves (41) that coincide with the one or more water passages having a groove shape (25) passing through the second valve section (20) to its outer surface;

wherein the central rotary dosing body (1), is located between the first (8) and second (20) valve sections housed in a cavity formed between the central circular a housing (11) (23) of the first and second section valves (8) (20), and wherein the central bore (4) of the central rotary dosing body (1) coincides with the central bores (12), (24) of the first (8) and second (20) section valves and the one or more passages having a groove shape (5) surrounding the central perforation (4) of the central rotary dosing body (1) coincide with the one or more water passages (13), (25), the first (8) and second (20) valve sections, to regulate or interrupt the flow of fluid in relation to the water passages (13), (25) of said first (8) and second (20) valve sections when the central rotary dosing body (1) is rotated;

wherein the first end (7) of the shaft (6) passing through the central bore (4) of the central rotary dosing body (1), passes through the central bore (12) of the first valve section (8), through the central bore (37) of the first external gasket (36) and protrudes over the outer surface of the first valve section (8) ending at its tubular thread connection (15) and the second end of the shaft passes through the central bore (24) of the second valve section (20), through the central bore (40) of the second outer gasket (39) and protrudes over the outer surface of the second valve section (20), ending at its threaded tubular connection (26), so that the central rotary dosing body (1) is able to rotatable about said axis (6);

wherein the first (7) and second shaft (6) receives a nut (42, 42′), thereby securing the shaft (6) to the first and second valve section;

means for rotating the rotating annular dosing body comprising:

a section having gear teeth (43) formed at a portion of the periphery of the central rotary dosing body;

a rotating member comprising:
an elongated metallic cylinder (44) having a first end (45) and a second end (46),
a cylindrical protrusion (47) protruding from the first end (45) of the elongated metallic cylinder (44), which tightly passes through the central bore (17) of the eccentric circular housing (16) of the first valve section (8) and rotates therein, said cylindrical protrusion having an end surface (48) perpendicular to a longitudinal axis of the metal cylinder, said end surface (48) having an indicator (49), wherein said end surface (48) bulges outward of the first valve section (8) and is coplanar with the outer surface such that is surrounded by the circular measurement mark (19) located at the outer surface of the first section valve (8);
wherein the first end of the elongated metal cylinder (45) is housed in the eccentric circular housing (16) of the first valve section (8) and rotates therein;
wherein the second end (46) of the elongated metal cylinder (44) is housed in the eccentric circular housing (27) of the second valve section (20) and rotates therein, said second end (46) having an end surface (50) which is perpendicular to a longitudinal axis of the elongated metallic cylinder (44), said end surface (50) having engagement protuberances (51) which exit through the central bore of the eccentric circular housing (27) towards the cylindrical tunnel (29) located at the outer end of the second valve section (20);
an annular section having gear teeth (52) formed at the middle longitudinal portion of the elongated metal cylinder (44), said annular section having gear teeth (52) engaging with the section having gear teeth (43) formed at a portion of the periphery of the central rotary dosing body (1);

wherein in order to rotate the central rotary dosing body (1), a key (53) is introduced through the cylindrical shaped tunnel (29) located on the outer side (21) of the second valve section (20), said key (53) having one end with a specific shaped cross section (54) that fits with the engagement protuberances (51) of the end surface (50) of the second end (46) of the elongated metallic cylinder (44), so that when the key is turned (53), it rotates the elongated metallic cylinder (44) and the annular section having gear teeth (52) which engages with the section having gear teeth (43) formed in a portion of the periphery of the central rotary dosing body (1).

wherein upon rotation of the elongated metallic cylinder (44), the indicator (49) located at the end surface (48) of the cylindrical protrusion (47) also rotates, pointing to the circular measurement mark (19) located on the outer surface the first valve section (8), which allows to rotate the elongated metal cylinder (44) by the key (53) and therefore to precisely rotate the central rotary dosing body (1) with the aid of the measuring mark (19) in accordance with the above described.

Although it was previously described that the means for attaching the valve to a pipe comprise a tubular threaded connection, said means may be a flange or any other similar or equivalent means (not shown).

Also, although it was described that both the elongated metallic cylinder (44) as well as the periphery of the dosing body rotary (1) have gear teeth, both elements may have any means that allow that the elongated metal barrel (44) may act on the periphery of the central rotary dosing body (1), such as surfaces that have a high friction coefficient.

Likewise, it will be apparent to one skilled in the art, that an end of the metal elongated metallic cylinder (44) may be connected, for example, to an electric motor, to move the elongated metallic cylinder (44) and the central rotary dosing body (1).

It should finally be understood that the invention is not limited to the discussed form of the various elements described above and that persons of ordinary skill in the art may suggest changes in the type and design of specific components of the valve with rotating system block flow of the present invention, derived from the teachings described herein, and which remain within the true spirit and scope of the invention as claimed in the following claims.

It should be finally understood that the valve having a rotary flow blocking system having a mechanism to regulate the opening of the rotary flow blocking system of the present invention, is not limited to the embodiments formerly described and that the persons skilled in the art will be able, by the teachings herein disclosed, to carry out changes in the valve having a rotary flow blocking system having a mechanism to regulate the opening of the rotary flow blocking system of the present invention, which will be within the true scope of the invention, which will be set forth exclusively by the following claims.

1. A valve having a rotary flow blocking system having a mechanism to regulate the opening of the rotary flow blocking system, said valve having a rotary flow blocking system comprising: a first valve section and a second valve section valve, each including a central bore; an inner surface and an outer surface; and one or more flow passages surrounding the central bore; the outer end of each valve section including means for connecting to a pipe; a rotary dosing body located between the first and second valve sections, including: a peripheral surface; a central bore; and one or more fluid passages surrounding the central perforation to regulate or interrupt the flow of fluid, said flow passages coinciding with the flow passages of the first and second valve sections; a shaft passing through the central bore of the first valve section; wherein the valve having a rotary flow blocking system having a mechanism to regulate the opening of the rotary flow blocking system is characterized by comprising:
means for rotating the rotary dosing body located between the first valve section and the second valve section, said means for rotating the rotary dosing body comprising a rotating element that having a tractive surface that cooperates with the peripheral surface of the rotary dosing body, such that when the rotating member rotates, it rotates the rotary dosing body.

2. A valve having a rotary flow blocking system having a mechanism to regulate the opening of the rotary flow blocking system as claimed in claim 1, wherein:
the peripheral surface of the rotary dosing body has gear teeth;
the tractive surface of the rotating member has gear teeth that engage with the gear teeth of the peripheral surface of rotary dosing body.

3. A valve having a rotary flow blocking system having a mechanism to regulate the opening of the rotary flow blocking system as claimed in claim 1, wherein:
the peripheral surface of the rotary dosing body has gear teeth formed on said peripheral surface;
the means for rotating the rotary dosing body comprising:
an elongated metallic cylinder having a first end and a second end;
a cylindrical protrusion protruding from the first end of the elongated metallic cylinder, which tightly passes through the central bore located at the first valve section and rotates therein;
wherein the second end of the elongated metal cylinder is housed in a housing located at the second valve section and rotates therein, said second end having an end surface which is perpendicular to a longitudinal axis of the elongated metallic cylinder, said end surface having engagement protuberances which exit through a central bore located at the second valve section;
an annular section having gear teeth formed at a middle longitudinal portion of the elongated metal cylinder, said annular section having gear teeth engaging with the section having gear teeth formed at a portion of the periphery of the central rotary dosing body.

4. A valve having a rotary flow blocking system having a mechanism to regulate the opening of the rotary flow blocking system as claimed in claim 1, wherein:
the peripheral surface of the rotary dosing body has gear teeth formed on said peripheral surface;
the means for rotating the rotary dosing body comprising:
an elongated metallic cylinder having a first end and a second end;
a cylindrical protrusion protruding from the first end of the elongated metallic cylinder, which tightly passes through the central bore located at the first valve section and rotates therein;
wherein the second end of the elongated metal cylinder is housed in a housing located at the second valve section and rotates therein, said second end having an end surface which is perpendicular to a longitudinal axis of the elongated metallic cylinder, said end surface having engagement protuberances which exit through a central bore located at the second valve section;
an annular section having gear teeth formed at a middle longitudinal portion of the elongated metal cylinder, said annular section having gear teeth engaging with the section having gear teeth formed at a portion of the periphery of the central rotary dosing body;
wherein in order to rotate the central rotary dosing body, a key is provided that has a shape that engages with the engagement protuberances of the end surface of the second end of the elongated metallic cylinder, so that when the key is turned, it rotates the elongated metallic and its gear teeth which engages with the gear teeth formed at the periphery of the rotary dosing body;
wherein upon rotation of the elongated metallic cylinder, the indicator located at the end surface of the cylindrical protrusion also rotates, pointing to the circular measurement mark located on the outer surface the first valve section, which allows to rotate the elongated metal cylinder by the key and therefore to precisely rotate the central rotary dosing body with the aid of the measuring mark.
